(19) United States
(12) Patent Application Publication
(10) Pub. No.: US 2010/0030382 A1
(43) Pub. Date: Feb. 4, 2010

(54) INHALABLE PARTICULATE ENVIRONMENTAL ROBOTIC SAMPLER

(75) Inventors: Stuart L. Shalat, Gillette, NJ (US); Adam A. Stambler, Hillsdale, NJ (US)

Correspondence Address: FOX ROTHSCHILD LLP;PRINCETON PIKE CORPORATE CENTER, 997 LENOX DRIVE, BLDG. #3, LAWRENCEVILLE, NJ, 08648, US

(73) Assignee: UNIVERSITY OF MEDICINE AND DENTISTRY OF NEW JERSEY, Somerset, NJ (US)

(21) Appl. No.: 12/512,350

(22) Filed: Jul. 30, 2009

Related U.S. Application Data
(60) Provisional application No. 61/137,672, filed on Jul. 31, 2008.

(51) Int. Cl. G05B 15/00; G01N 7/00; B25J 5/00; B25J 19/02

(52) U.S. Cl. 700/258; 73/23.2; 901/1; 901/46

(57) ABSTRACT

A robotic sensor measures air quality characteristics as experienced by a toddler, such as a child of six to twelve months in age. The robot includes an air quality sensor, a terrain drive train, a sensor drive train and a control circuit that controls the terrain drive train and the sensor drive train. The control circuit directs the terrain drive train to traverse an area at a speed and a start and stop rate consistent with that of a child and directs the sensor drive train to control the monitoring height at which the air quality sensor measures the air quality characteristic in a manner consistent with that of the child.

### CROSS-REFERENCE TO RELATED APPLICATIONS

This application claims the benefit of U.S. Provisional Application 61/137,672 filed on Jul. 31, 2008, the contents of which are incorporated herein by reference.

### STATEMENT REGARDING FEDERALLY FUNDED RESEARCH

The Research Leading to the present invention was supported in part, by a pilot grant from the NIEHS Center Grant (P-30-ES-05022); additional support was provided by a U.S.E.P.A STAR Grant (R827440), and a NIEHS (R01-ES014717) Grant. Accordingly, the U.S. Government may have certain rights in this invention.

### FIELD OF THE INVENTION

The present invention relates generally to air samplers. More particularly, the present invention discloses a robotic air sampler that allows for sampling at heights and conditions characteristic of the breathing zone of small children.

### BACKGROUND OF THE INVENTION

There is growing scientific evidence linking early childhood exposure to environmental agents with asthma and other illnesses that may not appear until later in life. Unfortunately the direct measurement of personal exposures of children in the first year of life is not possible by existing methodologies.

The concern over the steady increase in the number of children who are diagnosed annually with asthma has led to increased research into possible environmental factors in the origin of this condition. A variety of chemical and biological agents that can be present in the home have been implicated as having an etiologic role in asthma; these include second-hand smoke, pesticides, dusts, molds, fungi, and other allergens. Over the last ten years there has been increasing evidence that acute asthma symptoms are not just induced by allergens and pollutants, but that these agents may also play a significant role in the cause and/or development of asthma in early childhood. Additionally there are concerns over the role of early childhood exposure in the development of asthma later in life. While studies have examined the role of various environmental toxins in triggering respiratory symptoms in school age asthmatic children, relatively little research has focused on the youngest children (six to twelve months old) and the role environmental exposures play in the earliest stages of this condition. Further, the issues on the ability to safely use personal monitoring devices on very young children have made more accurate exposure characterizations problematic.

In older children the importance of the “personal dust cloud” and its role in asthma has been an area of recent research suggesting that personal monitoring is more relevant than general area monitoring. The problem that arises with personal monitoring of the youngest children, those in the first year of life, is that placing sampling pumps on them is just not a realistic or ethical option. First, the weight of the equipment is quite significant next to that of a child under the age of one year. Second is the propensity for children of this age, who are often teething, to put objects in their mouths. Lastly, these children spend much of their time learning to crawl, playing on the floor and exploring various surfaces. Thus, to obtain personal exposure data during these activities is impossible because the current personal monitors are too large and impractical for young children to wear.

Accordingly, there is an immediate need for improved air monitoring methods and systems.

### SUMMARY OF THE INVENTION

In one aspect a method for monitoring the air quality of an area is disclosed. Various embodiments of this method include disposing an air quality sensor module on a movable platform. The movable platform is then configured to autonomously traverse the area at a speed and stop and start rate consistent with that of the target group. The air quality sensor is used to take at least one air quality measurement at a height from the ground consistent with that of the target group while the movable platform is traversing the area. In preferred embodiments the movable platform traverses the area at a speed and stop and start rate consistent with that of an average child six to twelve months of age. The height of the sample is preferably taken at the appropriate height to be consistent with the breathing zone and type of activity the child would be engaged in and varies accordingly during the course of the sample collection.

In another aspect an air monitoring device for measuring an air quality characteristic is disclosed. A preferred embodiment of the device includes an air quality sensor for measuring the air quality characteristics, a terrain drive train for moving the device, a sampling platform drive train for controlling the monitoring height from the ground of the air quality sensor, navigational sensors, a bidirectional microwave radio link and a first control circuit. The first control circuit is mounted on the terrain drive train, controlling the terrain drive train and the sampling platform drive train, and comprises one or more processors and memory. The navigational sensors communicate with the control circuits. The radio link communicates between the first control circuit and a second control circuit, which may be a laptop computer. The memory includes program code that is executable by the processors to control the terrain drive train to traverse an area at a speed and a start and stop rate consistent with that of a target group and to control the sensor drive train to control the height from the ground at which the air quality sensor measures the air quality characteristic in a manner consistent with that of the target group. The program code and the control circuits also process the information from the navigational sensors to avoid obstacles. Preferably, the first control circuit performs obstacle avoidance.

In certain preferred embodiments the terrain drive train has a contact surface area with the ground that is substantially equivalent to that of the target group, and in particularly preferred embodiments the target group is indicative of a child of six to twelve months in age.

### BRIEF DESCRIPTION OF THE DRAWINGS

FIG. 1 is block diagram of an embodiment Pre-toddler Inhalable Particulate Environmental Robotic (PIPER) sampler

FIG. 2 shows a embodiment PIPER sampler.

FIG. 3 shows another embodiment PIPER sampler with a sampling pump and IOM inhalable particle sizing sampling head.

FIG. 4 shows a yet embodiment PIPER sampler with a real-time particle sampler sensor module.

FIG. 5 shows indoor activities of children one year of age and younger.

FIG. 6 shows a comparison of inhalable particle mass concentration (μg/m³) for an embodiment PIPER sampler and a stationary sampler.

FIG. 7 shows a comparison of particle concentration (μg/m³) as measured by another embodiment PIPER sampler and a stationary measurement station equipped with pDR-1000 passive samplers.

FIG. 8 is a specific embodiment flowchart for controlling an embodiment robotic platform.

FIGS. 9A and 9B show another embodiment PIPER device, in which FIG. 9A is a side view of the device and FIG. 9B is a top view of the device.

FIG. 10 is another flowchart of an embodiment method employed for robotic sampling.

FIG. 11 is an embodiment activity profile table.

### DETAILED DESCRIPTION

Since children six to twelve months of age spend much of their time playing on the floor, they can be exposed to inhalable particulate matter (PM)<0.01 μm in diameter to approximately 150 μm in diameter. As a result of floor activities PM can become re-suspended from surfaces. Accordingly, it is becoming increasingly clear that an understanding of the microenvironment between 0 and 1 meters above the floor is critical in appreciating the potential exposure and hazard of suspended PM to children. In particular, the existence of a “personal dust cloud” that surrounds individuals supports the need to measure exposures in the air space that is breathed by young children in this near-floor environment, and associated with their typical activities. These otherwise settled dust particles are re-suspended as result of any activity on the floor. The greater the activity the greater the level of the dust cloud. Additionally, larger particles (>2.5 μm in diameter) are preferentially re-suspended by floor activities.

A more accurate characterization of the exposure of children in the first year of life is essential in order to improve our understanding of the possible role of allergens and pollutants in the development and the initiation of airway responses to asthmatic triggers. One solution to the exposure assessment of very young children without a personal monitor is the development of a new methodology that can effectively estimate exposures of children by the mounting of air monitors on a robotic sampler that can mimic the activity patterns completed while a child explores his/her world.

Various embodiments relate to a Pre-Toddler Inhalable Particulate Environmental Robotic (PIPER) sampler, an autonomous robotic platform for the sampling of inhalable particles. PIPER is unique in that it allows for sampling at various heights that are characteristic of the breathing zone of small children (for example, under one year of age). Since children this young cannot be fitted with personnel air sampling devices, PIPER offers a unique ability to characterize the exposure to a variety of environmental toxins to this highly susceptible population.

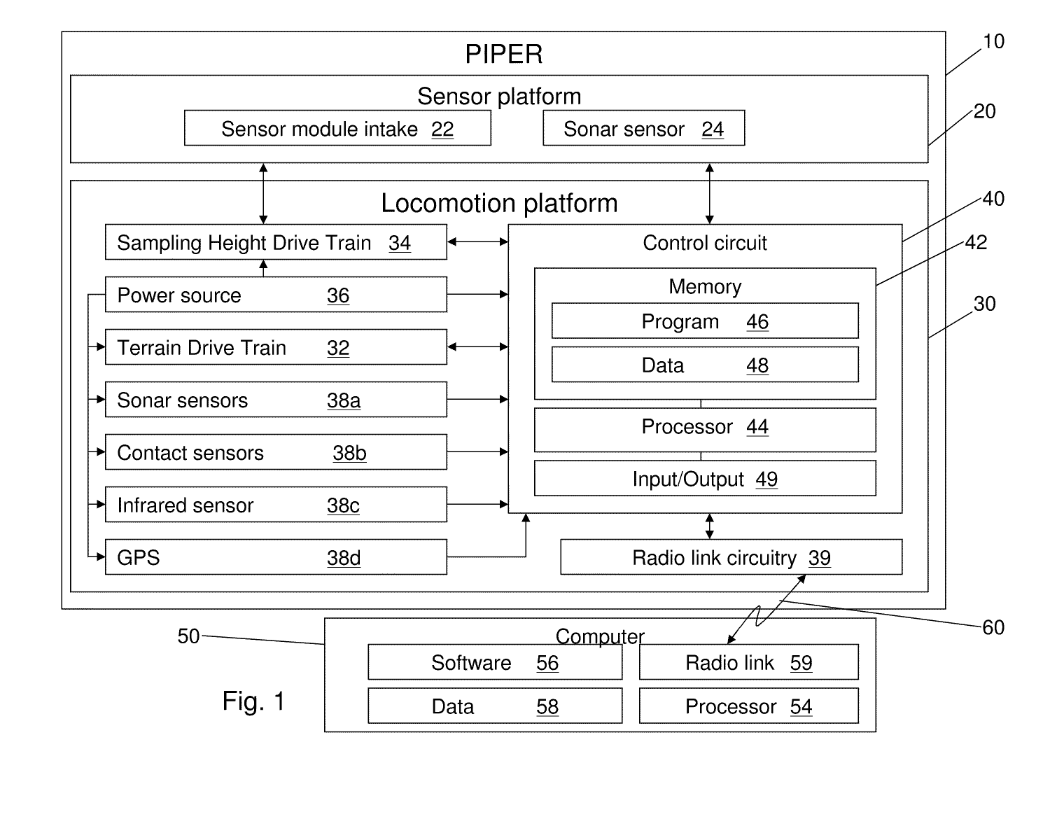

A block diagram of an embodiment PIPER sampler 10 is shown in FIG. 1. The PIPER device 10 includes a sampling intake platform 20 coupled to a locomotion platform 30. The locomotion platform 30 provides automated mobility of the sensor platform 20, and is capable of changing both the position and height of the sampling intake platform 20. The locomotion platform 30 includes a sampling platform drive train 34 and a terrain drive train 32. The terrain drive train 32 provides for mobility of the PIPER device 10 through an environment, such as a room, playground or the like. In preferred embodiments the terrain drive train 32 has a surface contact area with the ground that is substantially equivalent to that of a pre-toddler, such as about 80 cm². The terrain drive train 32 may include, for example, a plurality of wheels or continuous tracks, and further includes the related electrical motors and associated electrical systems. The sampling platform drive train 34 is coupled to the terrain drive train 32 and to the sampling platform 20 and is used to control the height of a sensor module 22, or an air intake of the sensor module 22, on the sampling platform 20. That is, the sampling platform 22 controls the height from the ground at which the sensor module 22 intakes one or samples for assay of air quality. The sampling platform drive train 34 includes one or more electrical motors coupled to a suitable mechanical device to controllably raise and lower the sensor platform 20. The range of motion of the sensor platform 20 is preferably from about 21 cm to about 100 cm above the ground. The sensor module 22 may be any suitable module known in the art to monitor one or more desired characteristics of air quality. The sampling platform 20 is thus used to changeably set the height off the ground at which such air quality measurements are performed by the sampling or sensor module 22, and the sampling platform drive train 34 is used to control this measuring height. In preferred embodiments the locomotion platform 30 carries four types of navigational sensors. These include four sonar sensors, four contact sensors, one infrared sensor and a GPS sensor. The sampling platform 20 may carry, for example, an additional sonar sensor 24. Additionally, a two-way radio link circuit 39 provides for communication with the locomotion platform 30. The radio link 39 and the sensors 38 are all linked to the onboard control circuit 40.

In certain preferred embodiments a computer system 50, preferably a laptop computer, runs suitably designed software 56 to link with the onboard control circuit 40 by means of a two-way radio link 60 provided by the radio circuitry 39 and similar corresponding circuitry 59 in (or controlled by) the computer 50. The computer software 56 is executable by a second processor 54 within the remote computer 50 to direct operations of the computer 50. In particular, the software 56 directs the computer 50 to transmit via radio link 60 instructions to the control circuit 40 that specifies the specific pattern of sampling. The control circuit 40 implements those instructions and directly controls the terrain drive train 32 and the sampling drive train 34 accordingly. The control circuit 40 also collects data from the navigational sensors 38 and acts directly on the terrain drive train 32 to avoid or take action when, based upon the navigational data received, the control circuit 40 determines that PIPER 10 has contacted, or is about to contact, obstacles in its path. The control circuit 40 may also transfer data on GPS coordinates obtained from GPS receiver 38d to the computer 50. The control circuit 40 via the radio link 60 may also confirm to the computer 50 the receipt of instructions. Together the computer 50 and the control circuit 40 may be used to control operations of both the sampling platform drive train 34 and the terrain drive train 32, and in particular control the servo for the sampling and the various drive motors. In other embodiments, all of the software needed to control the sampling operations and characteristics of PIPER 10 may be present within onboard software 46 and thus computer 50 is not required. However, by in effect “off loading” some of the sampling algorithms onto the remote computer 50 by way of software 56, updates to the sampling patterns and characteristics of PIPER 10 may be easily made simply by updating the software 56. Hence, in preferred embodiments the higher-level aspects of sampling are controlled by software 56, whereas the lower-level, autonomous functions of PIPER 10, such as control of the drive trains 32, 34, obstacle avoidance and the like are provided by on-board software 46, which controls PIPER 10 in accordance with higher-level commands received from radio link 60. It will be appreciated by one of skill in the art that greater or lesser amounts of control may be divided between the software packages 46, 56 to control all aspects of PIPER 10, and hence control circuit 40 and computer 50 may be collectively thought of as the “overall” control circuit of PIPER 10, though it is dispersed across discrete components, in which the onboard control circuit 40 is a first control circuit of the PIPER device 10 and the external computer 50 provides an optional second control circuit 50 for the device 10.

Power for the onboard control circuit 40, sensors 38 and the drive trains 32, 34 is provided by any suitable power source 36, such as a battery pack. In some embodiments the control circuit 40 may include two distinct processor boards, each for controlling a respective drive train 32, 34. In other embodiments, the control circuit 40 may simply have a single processor board that controls operations of both of the drive trains 32, 34. In either case, the layout of the processor board or boards is substantially the same, including at least one processor 44, such as a microcontroller, in communications with memory 42 and input/output (I/O) circuitry 49. In some embodiments, the I/O circuitry 49 may be integral with the processor 44. The memory 42 includes the program code 46 introduced above and data 48. The program code 46 is executable by the processor 44 and is used to control the operations of the control circuit 40, and by extension control of the sampling platform drive train 34 and the terrain drive train 32. The data 48 may include any data needed by the program code 46 to effect the desired operations, and it will be appreciated that this may vary depending upon how much of the software has been “off loaded” onto remote computer 50. The I/O circuitry 49 is used to facilitate communications between the processor 44 and the respective drive train 32, 34, as known in the art, with the sensors 38, with radio link circuitry 39, and optionally with the sampling platform 22. For example, the control circuit 40 may collect data from the sensor module 22 according to a predetermined collection routine and store sample data in the memory 42. Such data may then be retrieved at a later time for analysis, such as by downloading into the computer 50, as known in the art. Sample data may also be transferred via the radio link 60. Alternatively, the sensor module 22 may include its own memory for data collection purposes and its own I/O circuitry for programming and data uploading/downloading purposes. In particularly preferred embodiments the sensor module 22 may be easily detached and attached, both mechanically and electrically, from the sensor platform 20, such as by making use of standard pluggable I/O interfaces (RS-232, USB, etc.) and mechanical attaching mechanisms (metallic snaps and/or nylon straps with buckles, etc.). In preferred embodiments at least two separate sensor modules with a gross weight of 2 kg can be accommodated simultaneously.

In the following, the program code that implements the sampling method employed by PIPER 10 is discussed. As indicated above, this program code may be fully resident in onboard program 46, or may divided across both onboard program code 46 and external software 56. The following discusses this later embodiment, but this should not be inferred to disclaim those embodiments in which all necessary software is present in onboard program code 46.

The PIPER software 46, 56 is designed to allow the air quality breathing area sample to be collected in a manner representative of that experienced by a member of a desired target population, such as a child, and in particular of a child six to twelve months of age. More specifically, the program code 46, 56 is designed to cause the PIPER device 10 to move the sensor platform 22 to transverse an area in a manner that is consistent with that of an average member of the target population (i.e., a young child), and in particularly preferred embodiments of a child six to twelve months of age. The program code 46, 56 controls the terrain drive train 32 to move PIPER 10 at a speed that is typical of that of, for example, a child of the desired age and gender, and to intermittently start and stop in a manner that mimics the equivalent behavior in the child. In so doing, PIPER 10 may mimic the elutriation of particulate matter as experienced by the target population. The program code 46, 56 similarly directs the sampling platform drive train 34 to control the height of the sensor module 22 above the ground in a way that mimics the typical positioning of the nose and mouth of the target population. In certain embodiments the program code 46, 56 may control the sensor module 22 to direct when the sensor module 22 should take an air sample. In other embodiments, the sensor module 22 may autonomously sample the air in a manner predetermined by the sensor module 22, such as by pre-programming, default operating characteristics or the like. In some embodiments the control circuit 40 may accept sample data from the sensor module 22 and store this data, or a processed version of such data, in the memory 42. In other embodiments the sensor module 22 stores the air quality sample data itself, as numerically in an electronic memory or a magnetic memory, or physically as in a substrate, such as a filter pad or the like. In yet other embodiments the control circuit accepts sample data from the sensor module 22 and then transmits this data, raw or processed, to the computer 50 via radio link 60.

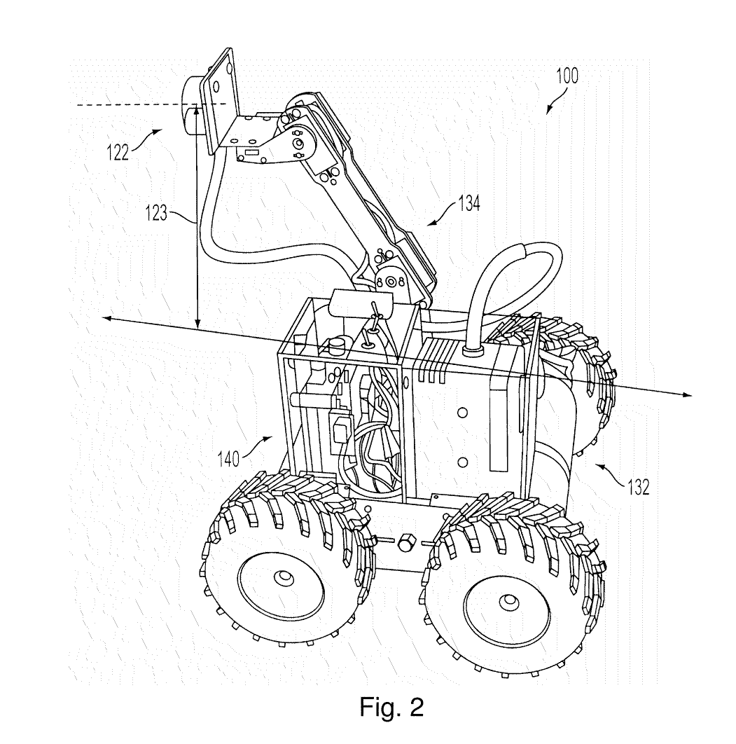

PIPER 10 provides a programmable autonomous environmental air sampler platform. Although PIPER 10 is in preferred embodiments tailored to sample environments in which children are present, in other embodiments PIPER 10 may also be deployed to sample for a variety of toxins in an environment that may not be safe to deploy personnel into, and sample in a manner that mimics the behavior of typical actors in the area. The PIPER platform 10 therefore is of potential value both to the general public health community, as well as having potential applications for defense and homeland security issues. It is capable of being equipped with a variety of air sampling pumps and sampling heads, as well as real-time monitors to accommodate the collection and evaluation of a wide variety of air contaminants under real-world sampling conditions. It can be commanded to sample a specific area, either indoors or outdoors. A perspective view of one embodiment PIPER device 100 is shown in FIG. 2. As part of the terrain drive train 132, the embodiment platform 100 includes two sponsons which are connected by a central axle. This allows each side of the embodiment PIPER device 100 to independently pivot vertically, thus facilitating the traversing of uneven outdoor terrain. As part of the sensor drive train 134, the platform 100 is equipped with a variable height sampling head mount, which can be continuously and precisely raised or lowered during operations. The PIPER robotic platform 100 may be constructed of PVC plastic with metal reinforcement. For the embodiment 100, the control circuit 140 includes a microcontroller which is programmable via a personal computer (PC) through an RS-232 or USB port (used as I/O) with, for example, compiled C programs. The microcontroller in turn controls two separate circuit boards, which are also used as I/O. One board is responsible for the operation of four drive motors in the terrain drive train 132 and allows variable and precise control of the speed of the device 100. The other circuit board controls the servo motors in the sensor drive train 134 that control the height above ground 123 of the sampling head of a sensor module 122. That is, the sensor drive train 134 controls the monitoring height 123 of the sensor module 122. The device 100 has four wheels, each of which is driven by a separate gear-reduced DC motor. The motors are under the direct control of the solid-state motor controller in the control circuit 140. Power is supplied by rechargeable batteries. The PIPER device 100 may also be equipped with an active ultra-sonic detector, which provides the device 100 with the ability to detect and avoid obstacles. The control circuit 140 includes radio circuitry and is thereby linked to an overarching control program resident on, for example, a laptop PC computer, by a two-way microwave radio link.

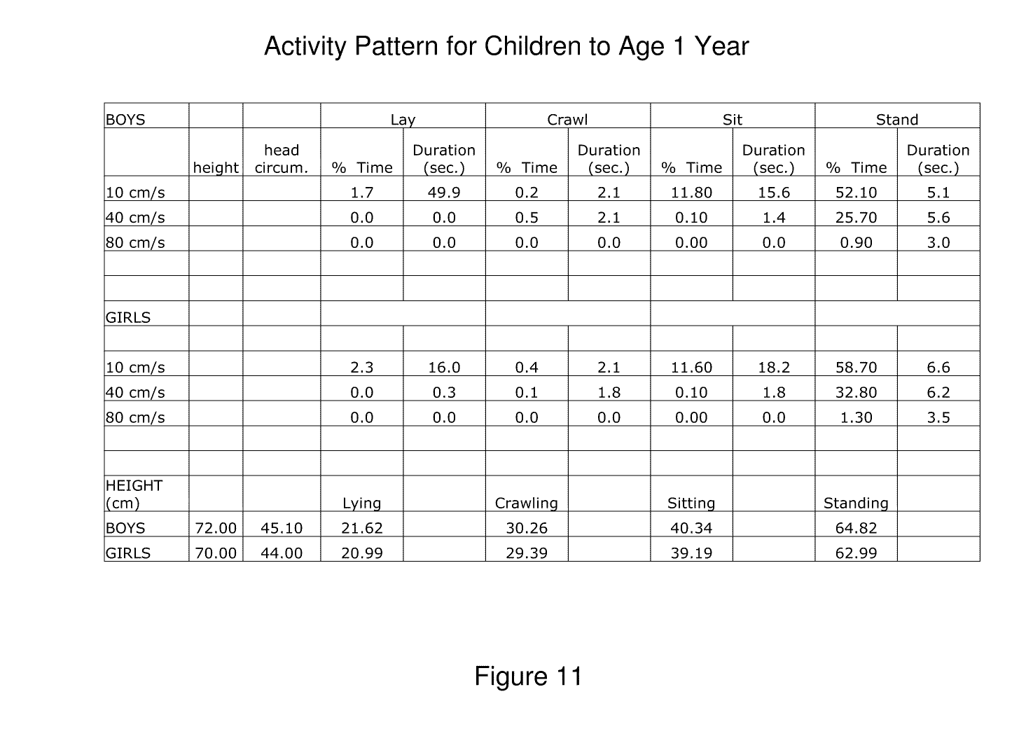

One aspect of PIPER 10 and its specific embodiments, such as the embodiment 100, is its control software 46, 56, which may be developed from, for example, a quantitative analysis of video recordings of the behavior of, for example, young children in their own homes. It is this software 46, 56 which allows PIPER 10 to move, as well as raise and lower its sampling head 20, in a manner consistent with that of the simulated population, such as children under one year of age. By way of specific example with children, the quantitative analysis of the video recordings may provide a predetermined number of key metrics on the relevant behavior to characterize the particulate environment, body posture, speed of movement, duration of posture and speed of movement, percent of time spent in this posture and speed of movement. These metrics are used to compute an activity pattern profile. By way of example, in order to define the activity pattern a detailed quantitative analysis of 70 children at play in and around their homes was carried out. A commercially available program was utilized to quantify the duration of the activities. A custom template was used to define the parameters of interest. The activities were quantified by playing back the video-recordings of individual children at play, while a trained technician viewed the playback using a Floor Contact Template, which indicated various ways in which the child interacts with the floor. Each time a change of activity was noted the technician noted this by clicking the computer mouse. The mouse click in turn started a timer, which stored that activity in a data base file for the child. The end result of the review is that each activity event the child undertook in the approximately four hour recordings was individually noted and stored in the database. The resulting file contained a long list of specific activities and the timed duration for each activity event. This data was then summarized for each individual child in how much time they spent in each activity, and the mean duration of each specific timed event was computed. This in turn was summarized for all the children by age and gender specific groups to create an activity profile. This summary information includes what amount of time (as in seconds) an individual child might spend in a specific activity and what percent of the observed period of time they spent doing that activity. It will be appreciated that although this is discussed with respect to a specific embodiment involving the activity profiles of young children, this approach is adaptable to describe any activity of any group of children, adults or even animals that is to be simulated by PIPER 10. The activity information in turn may be combined with information on velocity of activity and anthropromorphic data on stature and posture, for example as obtained from the published literature, to define an activity profile. Purely by way of example, a specific activity profile for children of about one year in age is shown in FIG. 11. As indicated in FIG. 11, various activities such as laying, crawling, sitting and standing were categorized. For each category, the average percentage of time spent in that category was computed, as well as the average amount of time spent doing that specific activity. Categories may be sub-divided based upon, for example, speed of movement, gender and so forth. The sampling height for each category or sub-category is also specified. It is noted that even for activities that may seem “stationary,” such as sitting, a speed parameter may still be specified to mimic shifting and other body movements with respect to the floor, as evidenced by the data depicted in FIG. 11. Consequently, the average activities of an individual or a group of individuals may be analyzed and partitioned into categories, each of which may indicate a state corresponding to the speed, movement characteristics and sampling height of the PIPER device 10 and have a corresponding frequency or probability of this state occurring and a duration. Individuals themselves may be further characterized, such as by age, gender or the like.

In certain embodiments this activity profile information may be stored as data 48 within the control circuit 40 and which the program 46 draws upon to control the movements and sampling patterns of PIPER 10, in conjunction with navigational information from the sensors 38. In such embodiments, once “set loose” in an environment the PIPER device 10 may autonomously collect air quality data until instructed to stop, such as by the computer 50. In other embodiments the activity profile is stored as part of the data 58 in computer 50 so that the higher-level aspects of the movement and air sampling characteristics of the PIPER device 10 are “off-loaded” onto the computer 50, which, via the radio link 60, sends wireless commands to the control circuit 40 to cause PIPER 10 to move about in a manner mimicking the activity profile of the simulated population and take corresponding air quality samples. In such embodiments, the onboard program 46 controls the sampling drive train 34 and terrain drive train 32 in accordance with state information received from the wireless instructions broadcast by the remote computer 50. In a specific embodiment the code 56 on the laptop 50 controls the overall time of sampling and the state (speed, sampling height, and duration of activity) that PIPER 10 operates in. The code 56 also randomly selects which state is selected. The code 46 in the control circuit 40 responds to obstacles detected by the sensors 38 to autonomously avoid such obstacles independently of the computer 50, and also directly controls the drive train 32 and the sampling platform drive train 34 in accordance with the state information and, except for obstacles, serves as a pass through from the computer 50 instructions. Hence, the manner in which the control circuit 40 controls the terrain drive train 32 and the sampling height drive train 34 may depend upon the specific state that PIPER 10 is in, and the duration of this state may be specified by the data 48, 58.

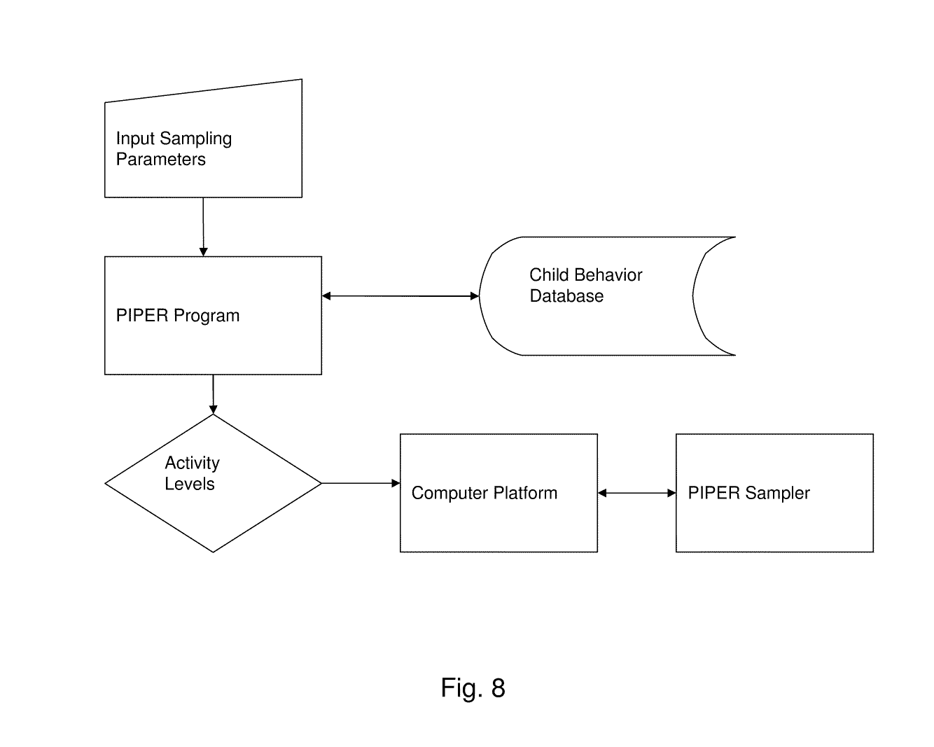

A specific embodiment for controlling PIPER 10 is illustrated in FIG. 8, in which aspects of the sampling characteristics are offloaded onto the computer 50. The user inputs into the PIPER PC program 56 the characteristics of the population to be simulated, such as the age and gender of the child, along with the length of time for which sampling is to be carried out by the PIPER device 10. The program 56 then reads from a stored activity file data 58 that corresponds to those characteristics selected. The PIPER PC program 56 then takes that data 58 and stores it in a multidimensional array that contains the state information for PIPER 10 and the probability of entering into each state. In conjunction with the length of time, this defines the robotic activity of PIPER 10. The computer platform 50 then conveys via the radio link 60 to the PIPER control circuit 40 the activity level to be replicated. As indicated earlier, an advantage of such embodiments is that activity profiles may be easily and conveniently changed on the computer 50 to change the sampling behavior of PIPER 10 without any need to explicitly change the program 46 or even the data 48 in PIPER 10 itself.

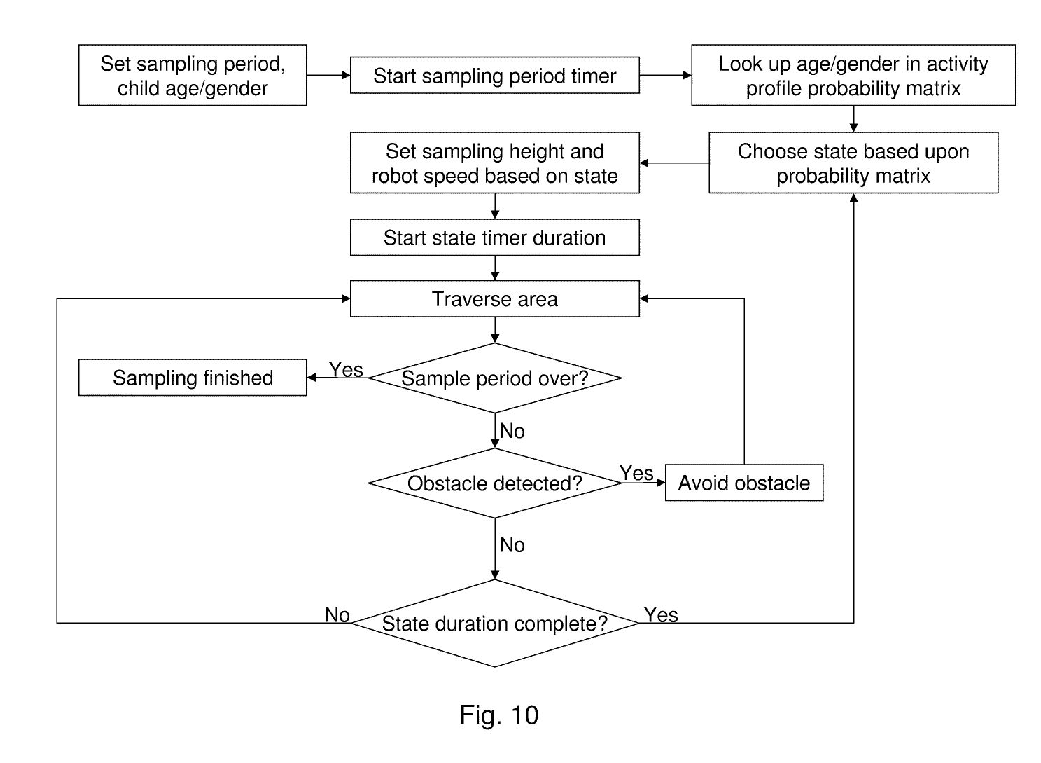

As previously discussed, the program 46 and, optionally, remote program 56, together control all aspects of PIPER 10 to perform a sampling routine that mimics the characteristics of a target population. FIG. 10 is a flow chart of an embodiment method used to control the sampling characteristics of PIPER 10, which is implemented by the software 46, software 56 or both. As indicated by FIG. 10, an operator first selects the specific characteristics of the population to be simulated, such as the age and gender of a child. The operator also indicates the total duration of the sample run, such as two hours or the like. A sampling period timer is then started to correspond to this duration. The selected characteristics are used to look up and generate a corresponding state probability matrix from a database containing activity profiles of the population. The state probability matrix comprises a plurality of states, each corresponding to an activity of the simulated population, and having a corresponding probability of occurring, a related speed, sampling height, duration and any other characteristic relevant to that state that PIPER 10 may simulate while in that state. Each probability is a weighted likelihood that the robot 10 will transition to that state. The robot 10 continuously transitions between states and samples the area for the duration of the specified sampling period. A state is thus randomly selected from the probability matrix in accordance with the probability values of the various states, and the sampling height, speed and other characteristics of PIPER 10 are set according to this selected state. A state timer is then set according to the duration value of the selected state. PIPER 10 traverses the sampling area for the specified duration of the state, collecting air quality data at the specified speed, and using the specified sampling height for the sensor 22 and any other relevant settings for that state. While the robot 10 is in each state, it moves through the area, avoiding any obstacles, and traverses the open ground under the specified state speed and characteristics. It also adjusts its air sampling platform 20 to sample at the designated breathing height dictated by the current state. The robot 10 traverses the area in a random path meant to assure equal coverage and avoid obstacles. This allows the robot 10 to measure the exposure throughout the environment being tested. If the sampling timer has expired, PIPER 10 terminates its sampling air quality routine. Otherwise, if the state duration timer expires a new state is randomly selected and the process continues accordingly. In certain embodiments the program 46, 56 keeps track of the total amount of time spent in each state. If, because of the random manner in which states are selected, this total time value for the state is excessive the program 46, 56 may instead select another state that does not have such an excessive total time value. By way of example, a total time value for a state may be deemed excessive when it exceeds the product of the total sampling duration and the probability for that state.

An objective of PIPER 10 is to support medical research and regulatory studies for the consideration of indoor air pollution as it applies to the exposure of, for example, young children. PIPER 10 is also useful for outdoor sampling for resuspendable particle pollution on hazardous waste sites, where it may not be desirable or feasible to send personnel. The motion of its terrain drive train 32 may result in the elutriation of surface material in a manner comparable to personnel walking through an area. Finally, PIPER 10 may have uses for both defense and homeland security purposes for collection of samples in areas contaminated with unknown chemical or biologic agents in a manner consistent with what personnel would experience in such areas.

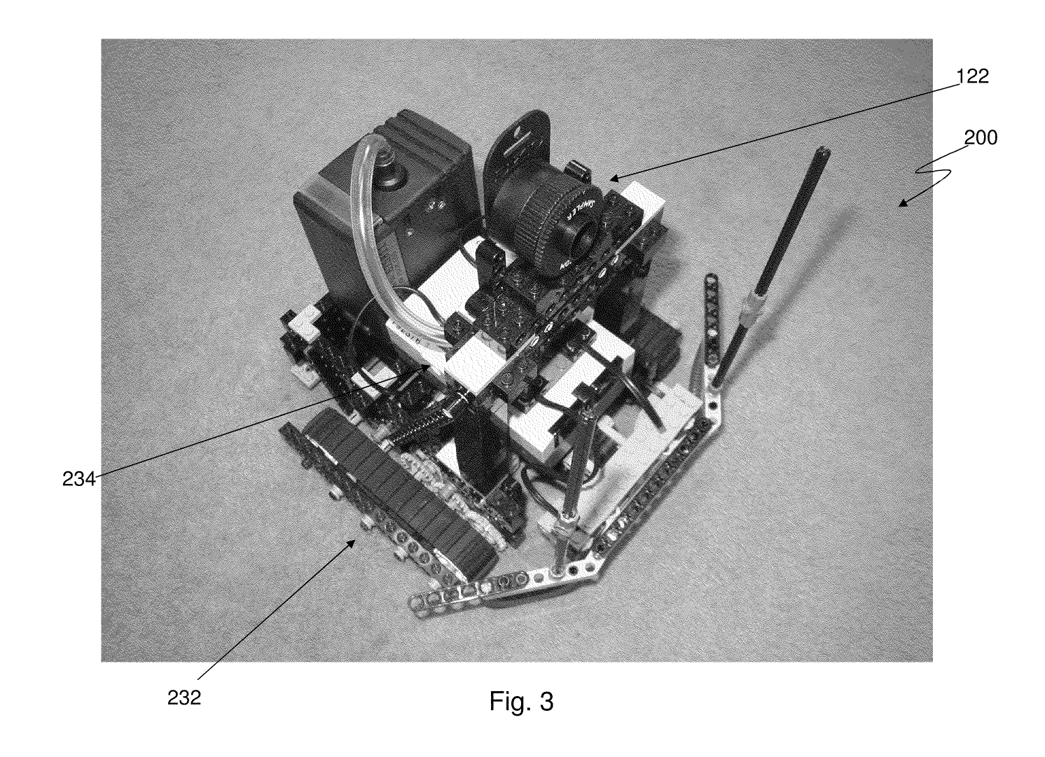

Another embodiment robotic sampler 200 is depicted in FIG. 3. The PIPER sampler 200 may provide an autonomous robotic platform as described above. The platform 200 may be programmed by means of a removable link to a separate PC. The PIPER device 200 utilizes a terrain drive train 232 and an articulated platform 234 to enable sampling on a variety of terrains, both indoors and outdoors. It may be equipped with sensors that allow it to detect the presence of stationary or moving objects in its path and to avoid those objects. The PIPER device 200 is equipped with a sampling mast 234 that can be raised or lowered, while sampling is in progress. This mast 234 mounts a sampling head 222, to simulate the breathing height of young children. The sampling parameters may be input into a PC-type computer, which may then be radio linked to the robot 200. The sampling parameters may be input as follows. The robot 200 may be programmed by inputting specific information relevant to the age and gender of the child for which surrogate sampling is desired. The operator then specifies whether the environment to be sampled is indoor or outdoors. The rough dimensions of the area to be sampled may then be input. Finally, the type of surface on which the sampling activities will be carried out may be entered. Once this information entered, the computer program 46 specifies a specific sampling algorithm for the PIPER device 200 to follow. The computer program 46 in response to the input parameters may specify the level of activity for PIPER 200, including velocity and frequency and durations of stops, and controls the terrain drive train 232 accordingly. In addition, it may also specify the sampling height and any changes in sampling height and the time and duration of sampling at each height, controlling the sensor drive train 234 accordingly as well as the sensor module 222. All of this allows the PIPER sampler 200 to obtain age and gender specific levels of exposure and environmental samples to airborne particulate matter and provides a monitoring platform that re-suspends particles during simulated child activities. Without wishing to be bound by theory it is believed that this is because when a child or an adult walks on a surface, the surface of the foot actually has a rolling action as the foot rolls from the heel of the foot to the toe. While this may not be perfectly replicated by a wheel, the contact pattern and area are replicated to a large extent by the rotating wheels, tracks or the like. In preferred embodiments the wheels or tracks are thus not covered on the top as this inhibits the re-suspension of particles that have settled on the surface. In other embodiments that contain top covers over the wheels, such as for placement of touch sensors, to facilitate dust re-suspension venturi ports are placed in the top surface of the drive train. This allows for improved navigation ability indoors, but still allows for the type of re-suspension of particles as would occur by foot falls.

In preliminary studies two series of measurements of inhalable particles were carried out. One collected filter samples of airborne inhalable particles and a second used a real-time total particle mass concentration monitor. Samples were collected for seven residential locations. Duplicate samples were collected with PIPER taking air samples at a height of 20 cm above the floor and from an identical stationary monitor positioned at a height of 110 cm above the floor.

The observed airborne inhalable particle concentrations measured by an embodiment PIPER device 10 had a mean of 98.6 μg/m³, while simultaneously collected stationary samples had a mean of 49.8 μg/m³. The average observed ratio of PIPER samples to stationary samples was 2.4. A paired t-test comparison of the two sampling methods indicated a statistically significantly higher level of inhalable particle concentration measured by PIPER in comparison with the fixed sampler (p<0.0001). Peak concentrations as measured by a real-time monitor were in excess of 3,600 μg/m³.

The results suggest that children playing on the floor are exposed to higher concentration of total inhalable particles than previous methodologies estimate. The application of robotic measurement platforms, such as PIPER 10, may thus offer a more relevant estimate of young children's exposure to airborne particles without requiring a child's presence or any active participation in the measurement process.

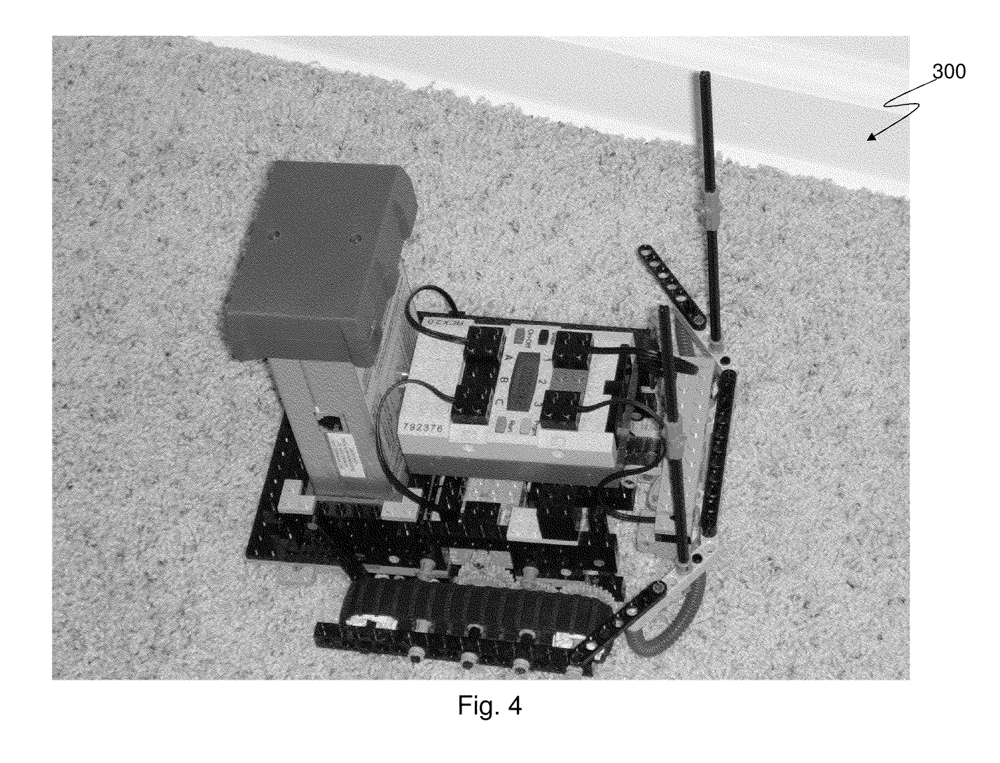

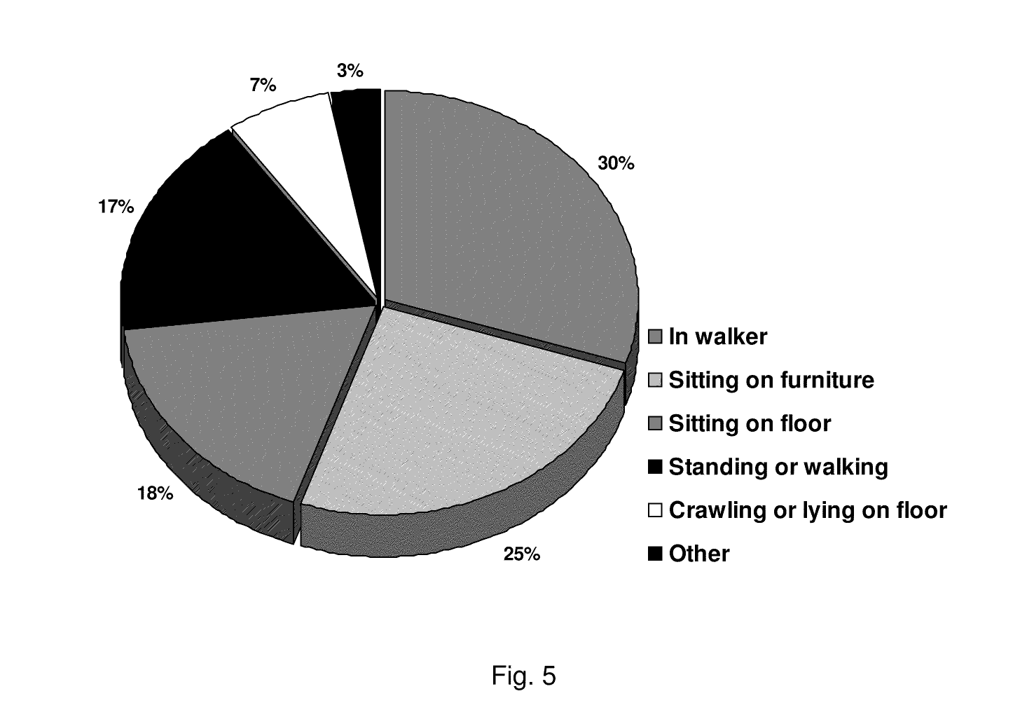

The prototype robotic platform 200, and another PIPER device 300 as shown in FIG. 4, may be designed and constructed based on the Robotics Invention System utilized by LEGO Mindstorms. This platform may be selected to design the prototype robotic system 200, 300 because of its low cost, ease of programming and in particular, for providing the ability to rapidly change and evaluate various design configurations to match the activities of the target population. A more durable sampler 100 capable of indoor as well as outdoor use is shown in FIG. 2. As part of the control circuit, the robots 200, 300 contain a central processor capable of receiving and storing commands sent by infra-red link from a separate laptop computer. These devices 200, 300 differ only in the type of air quality sampling device mounted on them. PIPER 200, 300 also has sensors that allow the device to detect objects and therefore to change directions when its motion is impeded. The programming of the robot 200, 300 is affected by links to a desk or laptop computer to allow the layout of any residence to be input into the sampler 200, 300. This programming allows reaction to obstacles (i.e. pets, toys, children), which could interfere with the operation of the robot 200, 300. The programming 46, 52 may be developed by utilizing the video library of children's behavior and activities from two studies that were previously carried out at the Environmental and Occupational Health Sciences Institute (EOHSI). Video recordings had been taken of children at play in and around their home for approximately 4 hours on a single day. The studies used to select typical children's activities were conducted in 1. a rural community in Texas and 2. urban and suburban New Jersey. The children evaluated ranged in age from 7 months to 5 years. The children in the rural Texas study spent a median of 7.8% of their time on the floor (i.e. sitting, crawling, lying), while those in New Jersey study spent 20.7% of their time in theses activities. A detailed breakdown of the floor activities of the children under 1 year of age (mean 8.6 months) is presented in FIG. 5.

PIPER 200, 300 may be programmed, based upon the video studies, to mimic the amount of time children spend stationary, as compared to time in motion, while playing on the floor. When in motion, the speed of PIPER 200, 300 may be designed to approximate the speed of a 6 to 12 month old child while crawling. To better simulate the movement of a crawling child who re-suspends particles from house dust while crawling, the terrain drive system of the platform 200, 300 may be equipped with treads. The treads on PIPER 200, 300 have a surface area of approximately 80 cm². This corresponded closely to the mean observed surface area of children in the Texas study who were under the age of one (a mean of 83.3 cm²). As a result, the terrain drive train of the PIPER device 200, 300 is able to mimic the elutriation of particulate matter from a floor as would be induced by a child under the age of one year. Additionally, PIPER 200, 300 may be programmed to maximize its coverage of the floor area of the specific room to be sampled. The amount of time in motion approximately corresponds to the amount of time the children were observed either crawling, lying on the floor playing or standing or walking in the video recordings of children under the age of one in the Texas study. For the under one year old children in the Texas study this corresponded to just under 60% of their time on the floor. The rest of the time they spend sitting and playing. PIPER 200, 300 may be programmed to move about the floor in a fixed pattern, based upon the dimensions of the room and the furniture it contained. Once started it may be programmed to continue in a straight line for a fixed time period, say about 5 seconds, and then came to a stop and pause for slightly longer than it had been in motion, say for about 8 seconds. This may be repeated for as many cycles as it takes to traverse the length of the room. The device 200, 300 may then be programmed to rotate through a predetermined number of degrees, preferably 90 degrees, and continued along the other dimension of the room in a similar manner. This overall process may continue for a full circuit of the room and then be repeated. If in the process the device 200, 300 encounters an object or person it may be designed to stop and turn and then continue off in the reverse direction.

The mobile platforms 200, 300 may be provided by alternately equipping PIPER 200, 300 with one of two types of personal environmental monitors. Initially the platform 200 is equipped with an AirLite pump from SKC Inc. (Eighty Four, Pa.) and an Institute of Occupational Medicine, Scotland (IOM) personal inhalable sampler (SKC Inc., Eighty Four, Pa.). Samples of airborne particles are collected onto Teflon (PTFE) filters at a flow rate of 2 l/min for gravimetric mass measurement. The IOM sampler has been widely used for sampling for inhalable particles that can penetrate into the respiratory tract. The efficiency for this sampler is between 80 to 100% for particles smaller than 10 μm in size and gradually decreases to 50% for particles of 100 μm in size. The inlet of this sampler may be set 20 cm above floor level in order to mimic a pre-toddler's breathing zone (age 6 to 12 months), while crawling on the floor. All filters may be pre-conditioned prior to use by placing them in a room with controlled temperature (20° C.) and humidity (30-40%) for 3 days prior to obtaining a pre-sampling weight.

In one study employing the PIPER 200, 300 devices, paired filter samples were collected from private residences (either apartment or single family house) using the IOM filter sampler. 4-hour samples were simultaneously collected for both PIPER 200 (20 cm) and the stationary monitor (height of 110 cm, according to the US EPA specifications). Occupants were asked to undertake no unusual cleaning of the room in advance of the sampling. The level of cleanliness of the room was noted at the time of sampling. The homes were tested during winter heating season. Sampling was performed in the main living area of the house, i.e., an area where a child would spend most of his/her playtime. To ensure that the PIPER robot 200 operated with a similar speed in each trial, a new set of batteries was installed for each new trial. The stationary monitor was positioned in the middle of the room so that it would be most representative of the IOM derived PM levels in the selected room. After a 4-hour sampling period, filters were removed from the IOM samplers, placed in sealed Petri dishes and returned to the laboratory. The pumps for the PIPER 200 and the stationary samplers were calibrated before the sampling using Buck calibrator (A.P. Buck, Inc., Orlando Fla.). After sampling, the final flow rates were measured with the same calibrator and the average of flow rates for t=0 and 4 hr were used to calculate the volume of sampled air. All flow rate measurements were performed in triplicate. Collected samples were allowed to re-equilibrate for 3 days in a weighing room with controlled temperature (20° C.) and humidity (30-40%), prior to weighing. Prior to each weighing, the calibration of the scale was verified with 200.000 mg and 50.000 mg weights. If deviation from calibration was detected, the scale was recalibrated with standard weights. In addition, as an internal control of the weighing procedures, a set of three blank filters was always kept in the weighing room and was weighted along each new set of field samples. A tolerance of 3 μg between repeats was considered acceptable.

A separate set of experiments was carried out with the robotic platform 300 equipped with a real-time particle mass concentration monitor (model pDR-1000, Thermo Electron Corp., Franklin, Mass., USA). This passive sampling device measures the mass concentration of total suspended airborne particles and has the best response in 0.1 to 10 μm size sampling range. One real-time mass monitor was mounted on the PIPER 300 (inlet at 20 cm from the floor) while an identical model was simultaneously employed as a stationary monitor (inlet at 110 cm from the floor). Two separate residences were evaluated, one an apartment and the other a single family house; each was sampled for 2 hours. The evaluations were performed with similar room placements to the filter sampling testing. Prior to each measurement, the two real-time particle mass concentration monitors were re-zeroed and cross-calibrated to each other. Since the composition of the dust and its light-scattering properties in each household could be different, the real-time monitors were not calibrated against filter samples. While measurements were being carried out, the activity of people in the room was minimized to avoid additional re-suspension of dust particles. The sampled rooms all had wall-to-wall carpeting.

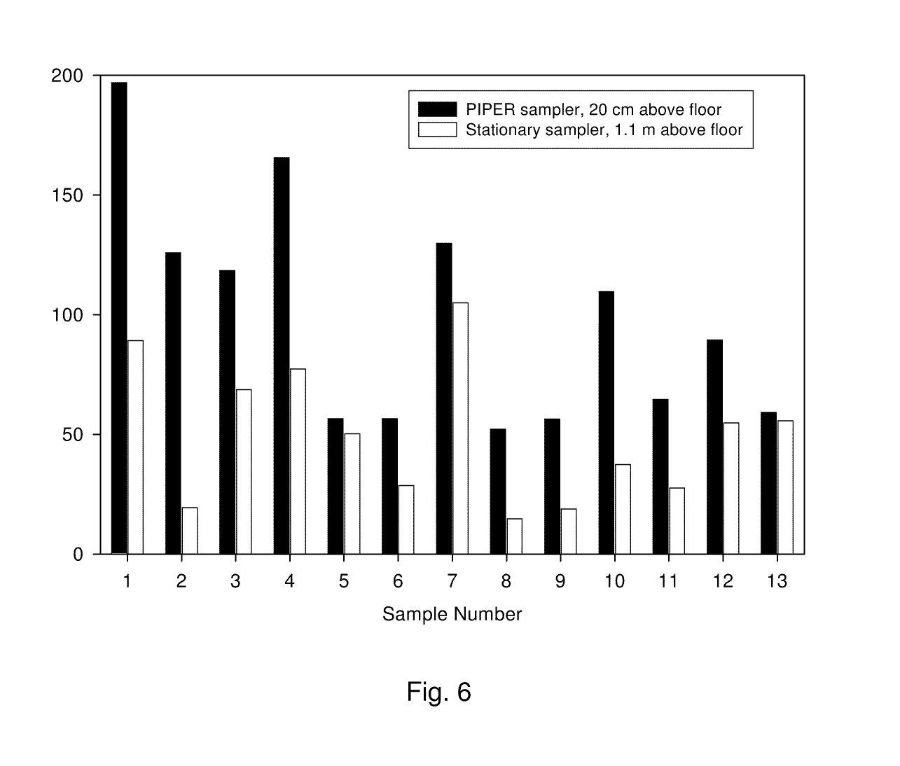

A total of thirteen paired filter samples were collected from seven residences. All of the sampled residence appeared to have an average level of cleanliness with no visible collections of dust. No pets were present in any of the dwellings. Occupants were present at the time of sampling and were only asked to observe PIPER 200 as they crossed the room to avoid collisions. The observed airborne inhalable particle concentrations measured by the robotic measurement platforms 200 ranged from 52 to 197 μg/m³ with a mean of 98.6 μg/m³, median of 89.5 μg/m³ and standard deviation of 47.1 μg/m³. Simultaneous measurements by the stationary sampler at the standard 110 cm level ranged from 14.7 to 104.9 μg/m³ with a mean of 49.8 μg/m³, median of 50.2 μg/m³ and standard deviation of 28.8 μg/m³. The average observed ratio of PIPER 200 samples to stationary samples in individual locations was 2.4 and ranged from 1.1 to 6.5, with 50% of sample ratios falling in the range of 2 to 3 fold higher inhalable particle concentrations measured by the PIPER sampler 200. These data are shown in FIG. 6. A paired t-test comparison of the two sampling methods indicated a statistically significantly higher level of inhalable PM measured by PIPER 200 in comparison with the stationary sampler (p<0.0001).

Separate analyses were carried out for the real-time particle mass concentration monitor pDR-1000 (Thermo Electron Corp., Franklin, Mass., USA) . When sampling the first dwelling, the device 300 was set to log 60 measurements per minute during its approximately two hours of operation. In the second dwelling the device 300 was set to log average readings per minute based upon the 60 measurements taken per minute. The latter method was determined to provide a more readily interpretable result. A total of 62 measurements were recorded in residence 1 and 121 measurements in residence 2.

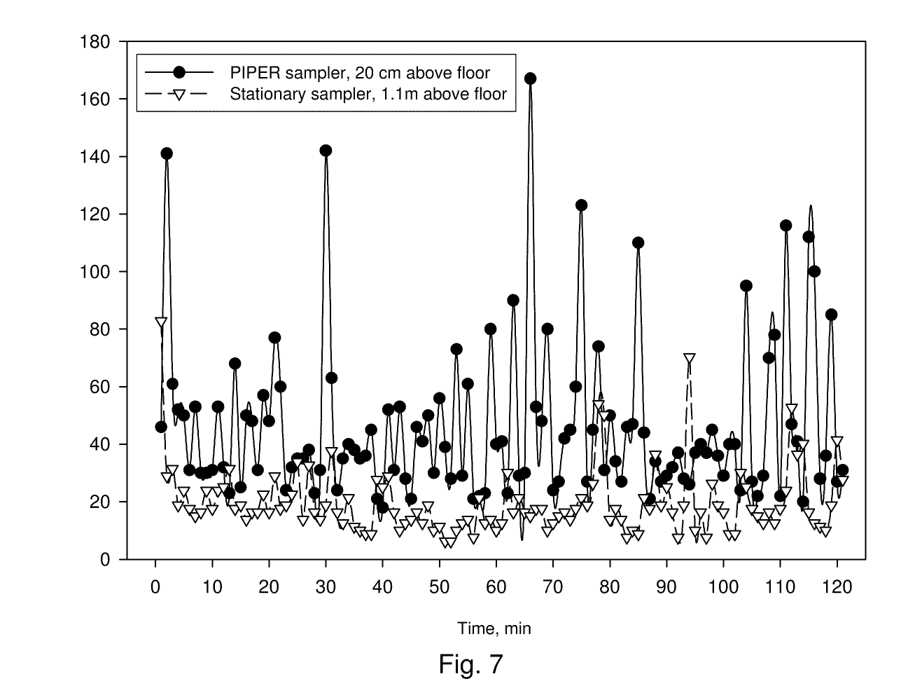

In the first dwelling, the PIPER sampler 300 measurements found the total suspended particle mass concentration to have an average of 52 μg/m³, while the stationary sampler observed an average of 18 μg/m³. In the second dwelling the concentrations were 46 μg/m³ and 20 μg/m³, respectively. The overall average inhalable concentration measured by PIPER 300 using the passive mass monitor was 46 μg/m³, while the stationary sampler measured 16 g/m³. The graph from the second dwelling, illustrated in FIG. 7, shows that the PIPER 300 results () are consistently higher than those measured by the stationary sampler (Δ). In addition, the ratio of airborne particle mass concentration for PIPER 300 versus the stationary sampler was 2.3. A similar pattern was observed for the other dwelling as well (data not shown), where a ratio of 2.8 was observed for airborne particle mass concentration for PIPER 300 versus stationary sampler. For both dwellings the mean PM concentration levels observed with PIPER 300 were statistically significantly higher (p<0.0001) than those measured with the stationary sampler. Real-time observations carried out on the mass concentration readout using the PIPER 300 indicated that aerosol dust levels would increase whenever PIPER 300 went in motion and decrease whenever PIPER 300 stopped moving. This suggests that not only does a “personal dust cloud” exist, but that motion on the floor causes particles to re-suspend and the total PM cloud will vary in mass concentration based upon the level of activity and the height of the measurement above the floor. In addition, there were significantly more and far higher transient peak concentration exposures for the PIPER 300 sample than for the stationary passive monitor samples. For example a maximum PM level collected by the real-time monitor using PIPER 300 was 167 μg/m³ for one minute and 3,657 μg/m³ for one second. In contrast, the peak concentration measured at the same time in the stationary monitoring position did not exceed 50 μg/m³ for one second. These differences were also found to be statistically significant (p<0.001).

Because a child's environment and activities are usually closer to the floor than an adult (<1.0 meters), the actual exposure received when playing on the floor may be significantly higher than predicted by elevated stationary monitors, as suggested by the above. This is likely to be true across a variety of size fractions including: total suspended particulate matter, PM10 (particles<10 μm in aerodynamic diameter), PM2.5 (particles<2.5 μm in aerodynamic diameter), and PM10-2.5. In addition, because of the higher settling velocity of the large particles, their presence in inhalable aerosols may be greater because of re-entrainment of previously settled particles. Finally, since personal monitoring of very young children cannot be achieved by existing devices, robotic methodologies for sampling are necessary to improve the estimates personal exposure for this susceptible population.

The above findings indicate that very young children can be subjected to levels of inhalable dust far greater than those experienced by the average adult in their homes. The levels at the 20 cm height were in general from 2 to 3 fold higher than USEPA standard height measures, but this in and of itself may not be the most important observation. During the period of time that PIPER 300 was in motion, the levels on the real time monitor were found to increase by up to two orders of magnitude, with the highest observed transient level observed being in excess of 3,500 μg/m³. This is more than seven times greater than the highest observed level on the stationary monitor. This may be of particular importance because this type of exposure event may both be relevant in the induction of asthma, as well as having a role in the initiation of an acute airways response.

The above observations are consistent with Ozkaynak et al.'s (1996) observation of a “personal dust cloud,” which because of the nature of children's activities, it is highly likely this cloud follows the individual around like the one always depicted around Charles Schultz's, Peanuts cartoon character “Pig Pen.” This suggests that to truly understand the total inhalable PM (i.e. the PM10 and PM2.5 environment) that a child is exposed to during the day, one must either apply personal monitoring, or in the case of children too young for the implementation of this approach, apply the robotic alternative presented by PIPER 10 to mimic the child's activities.

In summary, the PIPER 200, 300 results provided representative estimates of the total inhalable aerosol fraction and the PM10 fractions that pre-toddlers and young children playing on the floor may be exposed to in a residential setting. The measurements were able to be performed without the necessity of actual personal exposure monitoring of a child using a robotic system 200, 300 that was programmed to mimic aspects of a child's activities and carry filter based or continuous PM samplers. The presence of very high transient levels of inhalable PM in the floor level cloud raises some concerns about the need to measure such peaks in multiple homes with children at risk for asthma and or triggering asthmatic like symptoms. The total mass of suspended PM near the floor is significantly higher than that observed at the USEPA standard sampling height of 110 cm with a marked tendency for levels of total PM to increase with movement of PIPER on the floor. The application of the PIPER prototypes 200, 300 indicates that at the very least, inhalable particle exposure to young children during floor play may be greatly underestimated by conventional sampling methodologies, i.e., sampling at a height of 110 cm. Children do not live in a static environment, and they are constantly interacting with their surroundings; a point that has been established in the child behavior videography studies relating to environmental exposures. Finally, since it is not feasible to place personal monitors on very young children, the PIPER sampler system 10 appears to be a good option because of its ability to potentially duplicate the interactions between children and their environment. PIPER 10 represents a new direction for exposure estimation for very young children. By improving knowledge of this interaction, one can improve the understanding of how the dynamic environment in which a child exists can be more accurately characterized for exposures to a variety of contaminants that may exist in the home.

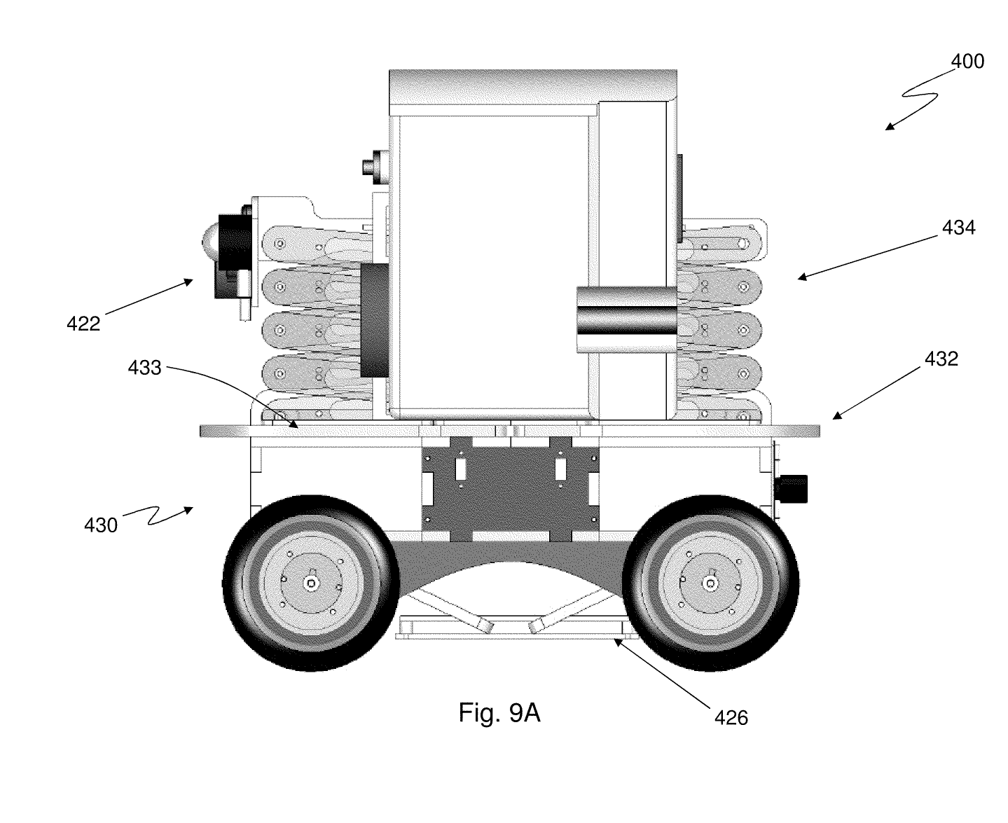

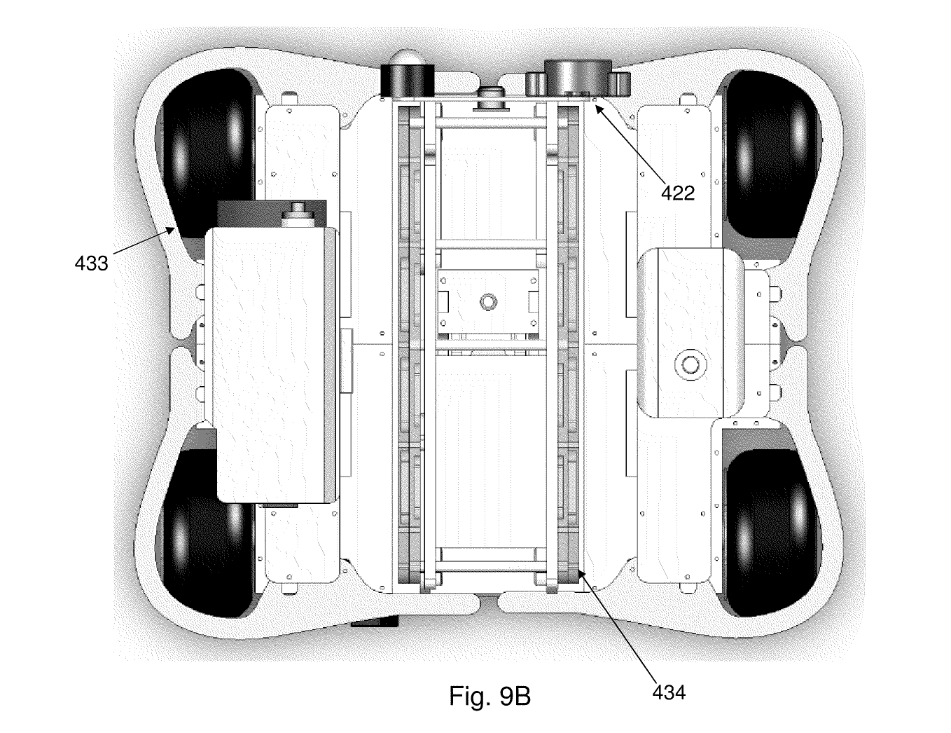

Another embodiment PIPER device 400 is shown in FIGS. 9A and 9B. The sampling platform drive train 434 includes a scissor lift to adjust the height of the sensor module 422. As indicated earlier, the terrain drive train 432 includes venturi ports 433 to allow for the re-suspension of particulate matter kicked up by the drive train 432. In addition, the sensor platform includes a swipe module 426 mounted to the bottom of the locomotion platform 430. The swipe module 426 may be in contact with the ground to take direct contact samples as the PIPER device 400 moves.

All publications cited in the specification, both patent publications and non-patent publications, are indicative of the level of skill of those skilled in the art to which this invention pertains. All these publications are herein fully incorporated by reference to the same extent as if each individual publication were specifically and individually indicated as being incorporated by reference.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A method for monitoring air quality of an area as experienced by an individual, the method comprising:
disposing an air quality sensor module on a movable platform;
configuring the movable platform to autonomously traverse the area at a speed and stop and start rate consistent with that of the individual; and
utilizing the air quality sensor to take at least one air quality measurement at a height from the ground consistent with that of the individual while the movable platform is traversing the area.

2. The method of claim 1 wherein the individual is an average child six to twelve months of age.

3. An air monitoring device for measuring at least an air quality characteristic as experienced by an individual, the device comprising:
an air quality sensor for measuring the air quality characteristic;
a terrain drive train for moving the device;
a sensor drive train for controlling the monitoring height from the ground of the air quality sensor; and
a control circuit for controlling the terrain drive train and the sensor drive train, the control circuit comprising at least a first processor and memory, the memory comprising first program code executable by the at least a first processor to perform the following step:
control the terrain drive train to traverse an area at a speed and a start and stop rate consistent with that of the individual.

4. The air monitoring device of claim 3 wherein the first program code further causes the at least a first processor to control the sensor drive train to control the height from the ground at which the air quality sensor measures the air quality characteristic in a manner consistent with that of the individual.

5. The air monitoring device of claim 3 wherein the terrain drive train has a contact surface area with the ground that is substantially equivalent to that of the individual.

6. The air monitoring device of claim 3 wherein the individual is an average child of six to twelve months in age.

7. The air monitoring device of claim 3 wherein the control circuit comprises a first control circuit mounted to the terrain drive train and a second control circuit in wireless communications with the first control circuit.

8. The air monitoring device of claim 7 wherein the second control circuit comprises a second processor and second program code executable by the second processor to cause the second control circuit to wirelessly transmit commands to the first control circuit, the commands comprising information indicating a speed of the terrain drive train.

9. The air monitoring device of claim 7 wherein the second control circuit comprises a second processor and second program code executable by the second processor to cause the second control circuit to wirelessly transmit commands to the first control circuit, the commands comprising information indicating a speed of the terrain drive train and a height of the air quality sensor.
